(19) United States
(12) Patent Application Publication
(10) Pub. No.: US 2012/0143589 A1
(43) Pub. Date: Jun. 7, 2012

(54) MULTI-MODAL COMPILING APPARATUS AND METHOD FOR GENERATING A HYBRID CODEFILE

(76) Inventors: Andrew Ward Beale, Mission Viejo, CA (US); Damian John Thomas, Rancho Santa Margarita, CA (US); Robert Joseph Meyers, Garden Grove, CA (US)

(21) Appl. No.: 12/962,271

(22) Filed: Dec. 7, 2010

(51) Int. Cl. G06F 9/455; G06F 9/45

(52) U.S. Cl. 703/26; 717/140

(57) ABSTRACT

A non-native, multi-modal compiler and an emulated computing environment for use in a native computing environment. The multi-modal compiler includes a parser configured to parse or divide received source code into a plurality of token elements, whereby at least one statement is recognized from a collection of token elements. The multi-modal compiler also includes a code emitter configured to emit machine code to implement the at least one statement, whereby the emitted machine code is compiled multi-modal object code that includes non-native operators (e.g., E-Mode operators) and NATV operators. The compiled multi-modal object code is configured in such a way that when translated by a code translation unit, the compiled multi-modal object code generates a merged codefile having translated native code segments corresponding to the non-native operators and native code segments corresponding to the NATV operators. The merged codefile is executable by a native processor in the native computing environment.

### BACKGROUND

1. Field

The instant disclosure relates generally to computing environments and data processing code generated and executed therein, and more particularly, to emulated or non-native compilers and the generation of hybrid codefile that includes both native code and non-native code.

2. Description of the Related Art

Native code is a type of computer programming information written and compiled for direct execution by a particular processor (i.e., the native processor) and the native processor's set of instructions. For example, a compiler reads instructions written in a particular computer programming language to generate native code that is directly executable by a brand-specific processor. However, native code compiled for one type or brand of processor often cannot be executed by another type of processor. Therefore, for each type of processor, the computer programmed instructions must be recompiled to generate native code for execution by or on that type particular type of processor.

By comparison, non-native code is not directly executed by a processor. An intermediate program, such as an interpreter, typically is used to execute non-native code. In turn, the intermediate program is directly executed by the processor. Functionally, the interpreter is a type of translator for reading non-native code and for generating native code for direct execution by the native processor.

In some computing environments, such as in many emulated computing environments, a compiler (and other programs or program applications) used in the emulated computing environment typically is not native to the native processor. Therefore, such a non-native compiler conventionally generates only non-native code, which then must be interpreted, e.g., using an interpreter, before the code can be executed by a native processor.

### SUMMARY

Disclosed is a multi-modal compiling apparatus for use as a non-native compiler in a native computing environment. The multi-modal compiler includes a parser configured to parse or divide received source code into a plurality of token elements, whereby at least one statement is recognized from a collection of token elements. The multi-modal compiler also includes a code emitter configured to emit machine code to implement the statement, whereby the emitted machine code is compiled multi-modal object code that includes non-native operators and NATV operators (e.g., E-Mode operators). The compiled multi-modal object code is configured in such a way that when translated by a code translation unit, the compiled multi-modal object code generates a merged codefile having translated native code segments corresponding to the non-native operators and native code segments corresponding to the NATV operators. The merged codefile is executable by a native processor in the native computing environment. The multi-modal compiling apparatus and its compiling methods allow for relatively significant speed improvements in emulated systems, as well as supplying a framework in which a multiplicity of execution environments can be supported with relatively high performance. Also, the multi-modal compiler can emit code for more than one processor target with all of the code in a single codefile. At load time, transformations are generated that merge the target processors' code with the necessary perquisite conditions, which, when executed, allow a relatively seamless transition between processors and instruction sets. By having compilers configured to emit a new instruction, i.e., a NATV operator that indicates foreign code is to be merged into the execution stream, a suitable interpreter/translation environment, such as an environment including dynamic binary translation, can generate a code stream that supports multiple execution environments.

### BRIEF DESCRIPTION OF THE DRAWINGS

FIG. 1 is a schematic view of a computing environment having a native operating system being run by a native processor and an emulated environment within the native operating system, according to a conventional arrangement;

FIG. 2 is a schematic view of a set of heterogeneous computing environments, including a processor environment and a data storage environment, according to a conventional arrangement;

FIG. 3 is a schematic view of a set of heterogeneous computing environments, including a processor environment and a data storage environment, according to an embodiment;

FIG. 4 is a schematic view of a multi-modal compiler within a computing environment, according to an embodiment;

FIG. 5 is a schematic view of a code segment portion of a non-native/NATV code segment, which includes both non-native operators and NATV operators, according to an embodiment; and

FIG. 6 is a flow diagram of a method for generating a hybrid code segment or codefile according to an embodiment.

### DETAILED DESCRIPTION

In the following description, like reference numerals indicate like components to enhance the understanding of the disclosed methods and systems through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

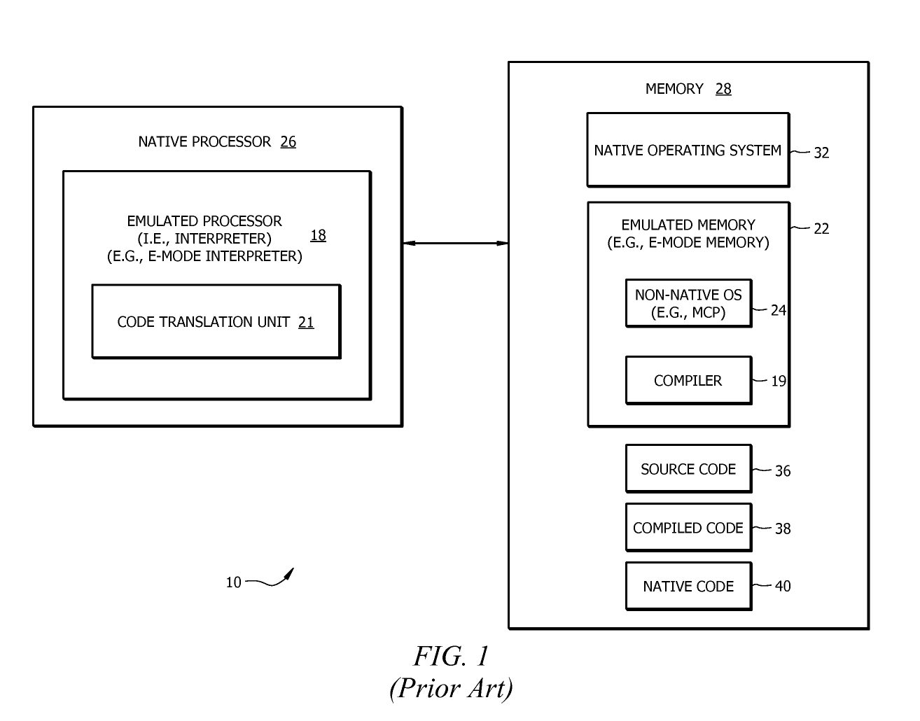

FIG. 1 is a schematic view of a computing environment 10 that can be or include an emulation or emulated environment. The emulated environment typically includes an emulated processor 18 (i.e., an interpreter), an emulated translator or code translation unit 21 that typically resides in the emulated processor 18, an emulated memory or memory element 22, an operating system (OS) 24 that typically resides in the emulated memory 22, and a compiler 19 that also typically resides in the emulated memory 22.

For example, if the emulated computing environment includes or involves a Master Control Program (MCP) environment, the emulated processor 18 is an E-Mode interpreter, the emulated compiler 19 is an E-Mode compiler or MCP compiler, the emulated code translation unit 21 is an E-Mode translator, the emulated memory is E-Mode memory, and the operating system 24 within the E-Mode memory is the MCP. As is known in the art, the MCP is a proprietary operating system used in many Unisys Corporation mainframe computer systems.

The computing environment 10 can be any suitable computing environment, e.g., a computing environment that includes a processor or native processor 26, a memory or memory device 28 coupled to the native processor 26, and an operating system or native operating system 32 residing in the memory 28. The memory device 28 can have residing therein various forms of code, e.g., source code 36, such as source code for a program A, compiled non-native code 38, such as compiled MCP object code for program A (e.g., E-Mode operators), and native code 40, such as translated code for program A. Also, as shown, the emulated processor 18 is executed by the native processor 26. Also, the emulated memory 22 is included as part of the memory 28, which also can be considered “platform memory” available to the native processor 26.

As discussed hereinabove, in an emulated environment, the emulated processor 18 typically is running as an application within an operating system, e.g., within the native operating system of another computing environment. Accordingly, the emulated environment often is referred to as a non-native environment, and the operating system 24 running within the emulated memory 22 often is referred to as a non-native operating system. Similarly, the compiler 19 within the emulated processor 18 often is referred to as a non-native compiler and the code translation unit 21 within the emulated processor 18 often is referred to as a non-native translator or code translation unit 21.

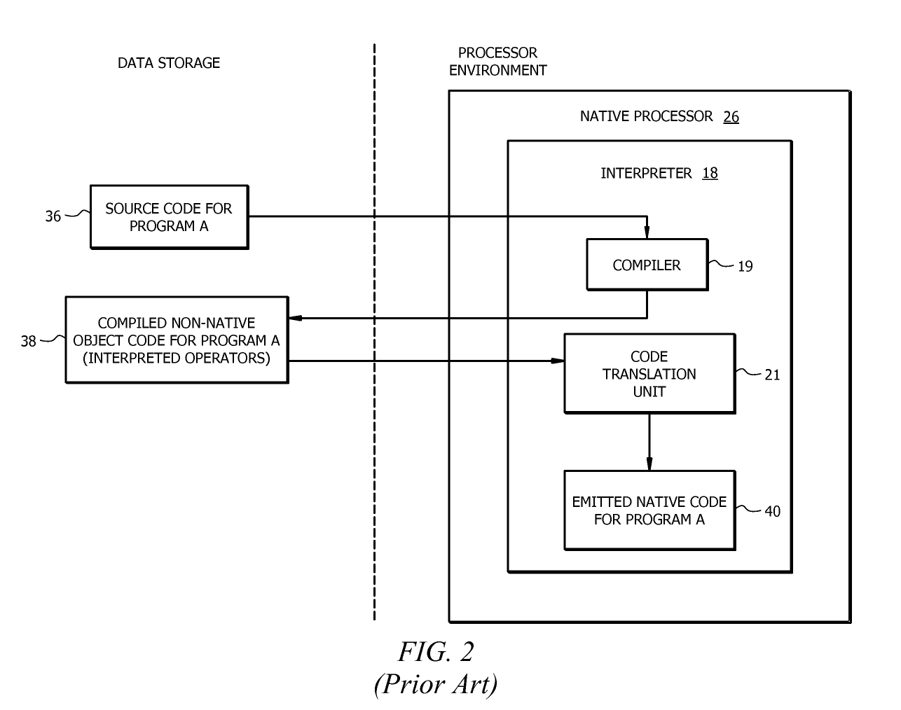

FIG. 2 is a schematic view of a set of heterogeneous computing environments, including a processor environment and a data storage environment, according to a conventional arrangement. In the processor environment, the emulated processor 18 is shown running as an application within the native processor 26. Also, the data storage environment shown typically represents a portion of the memory device 28, within which resides the native operating system. However, it should be understood that the data storage environment shown also can represent a portion of the emulated memory 22 or some other suitable memory or memory device coupled to the processor environment.

As discussed hereinabove, in some computing environments, such as in many emulated computing environments, the compiler 19 used in the emulated computing environment 16 typically is not native to the native processor 26. Therefore, such a non-native compiler conventionally generates only non-native code, which them must be interpreted, e.g., using the code translation unit 21, before the code can be executed by the native processor 26.

In general, an interpreter is a special class of program that interprets instructions, e.g., opcodes and operators, that are different than the native instruction set of the machine upon or application within which the interpreter is executing. It should be understood that the operators may include various types of data processing code, e.g., bytecodes or opcodes, depending on the particular non-native instruction set and the underlying programming language. Typically, the interpreter receives the code to be executed and translates the non-native computer instructions, typically written in a high-level programming language, into native computer instructions.

In general, a compiler is one or more programs that transforms source code written in a high-level programming language into a lower level computer languages, such as assembly language or machine code language. The transformed language generated by the compiler often is further transformed into an executable program by an assembler or a code translation unit into native code suitable for execution by the native processor.

As shown in FIG. 2, within the interpreter 18, the compiler or non-native compiler 19 receives the source code 36 for a particular program A from a data storage location, e.g., the memory device 28. The compiler 19 compiles the source code to generate a compiled non-native object code 38 for program A. Conventionally, the compiled non-native object code 38 for program A typically includes non-native operators, such as E-Mode operators. The code translation unit 21 receives the compiled non-native object code 38 for program A and translates the compiled non-native object code 38 into native code 40 for program A, which can be executed by the native processor 26. For example, see U.S. patent application Ser. No. 12/502,301, filed Jul. 14, 2009, entitled “Systems, Methods, And Computer Programs For Dynamic Binary Translation In An Interpreter”, which is incorporated herein by reference in its entirety.

As discussed hereinabove, a compiler used in the emulated computing environment typically is not native to the native processor. Therefore, such a non-native compiler conventionally generates only non-native code, which then must be translated before the code can be executed by a native processor. Therefore, it may be advantageous to provide system components and computing environments that support and facilitate multiple execution environments.

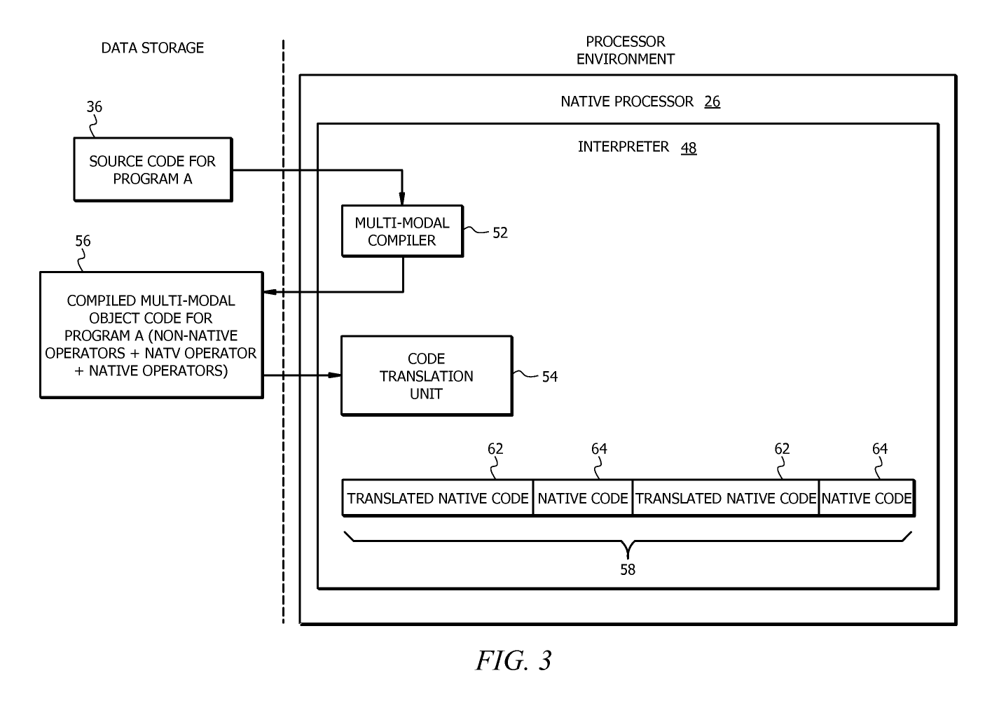

FIG. 3 is a schematic view of a set of heterogeneous computing environments, including a processor environment and a data storage environment, according to an embodiment. For example, an interpreter or other appropriate processing component includes a multi-modal compiler 52, configured according to an embodiment, as will be discussed in greater detail hereinbelow. In an emulated environment, an interpreter 48 (e.g., an emulated processor) running as an application within the native processor 26 can be configured according to an embodiment, e.g., the interpreter 48 can be configured to include a non-native compiler (i.e., the multi-modal compiler 52), configured according to an embodiment, and a non-native translator or code translation unit 54 compatible with the multi-modal compiler 52. For example, the non-native code translation unit 54 can be or include a dynamic binary translation (DBT) module that performs dynamic binary translation. Dynamic binary translation generally refers to a particular type of process that translates the binary code in an interpreter from the non-native code to the native code.

One or more of the multi-modal compiler 52 and the code translation unit 54 can be implemented in software, hardware, firmware, or any combination thereof. In certain embodiments, the module(s) may be implemented in software or firmware that is stored in a memory and/or associated components and that are executed by the interpreter 48 and/or the native processor 26, or any other processor(s) or suitable instruction execution system. In software or firmware embodiments, the logic may be written in any suitable computer language. One of ordinary skill in the art will appreciate that any process or method descriptions associated with the operation of the multi-modal compiler 52 and/or the code translation unit 54 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any computer readable medium for use by or in connection with an instruction execution system, apparatus, or device, such as a computer-based system, processor-containing system, or other system that can fetch the instructions from the instruction execution system, apparatus, or device and execute the instructions.

According to an embodiment, the multi-modal compiler 52 receives the source code 36 for a program A from an appropriate data storage location. Unlike conventional non-native compilers, which generate a compiled non-native object code 38 for program A that includes non-native operators only, the multi-modal compiler 52 compiles the source code 36 to generate a compiled multi-modal object code 56 for program A. According to an embodiment, the compiled multi-modal object code 56 includes code segments that have non-native operators (e.g., E-mode operators) and code segments that have both non-native operators and one or more inventive operators (i.e., NATV operators). As will be discussed in greater detail hereinbelow, according to an embodiment, NATV operators are used for the execution of native code, which typically resides directly behind the appropriate NATV operator. Therefore, the native code emitted from the multi-modal compiler 52 resides in the same code segment as the NATV operator that executes the native code.

According to an embodiment, the code translation unit 54 receives and translates the compiled multi-modal object code 56 into a single merged code or codefile 58, which includes one or more translated native code segments 62 and one or more native code segments 64. For example, for a code translation unit 54 that is or includes a DBT module, the translated native code segments 62 are made up of DBT native code. According to an embodiment, the inventive NATV operators have sufficient parameters (not arguments) to allow the code translation unit 54 to “merge” native code segments 64 emitted from the multi-modal compiler 52 with translated native code segments 62 from the translation. All of the code segments in the merged code/codefile 58 are executable by the native processor 26.

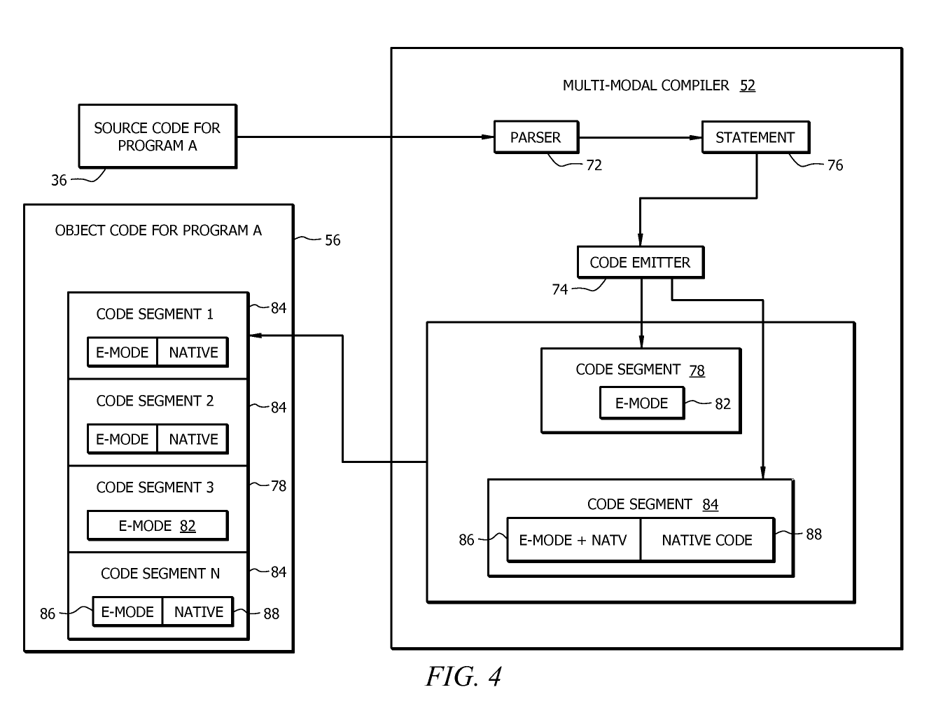

FIG. 4 is a schematic view of the multi-modal compiler 52 according to an embodiment. The multi-modal compiler 52 includes a parser 72 and a code emitter 74, among other components (not shown). The parser 72 is configured to scan the received source code 36 and divide or parse the source code into a plurality of units (tokens). As the tokens get recognized by the grammar of the language implemented by the multi-modal compiler 52, a statement 76 is recognized from a collection of tokens. In general, a statement 76 can be thought of as a collection of tokens representing a language entity to the multi-modal compiler 52. A statement can be declarative, e.g., declaring an integer, a real number or a structure. Alternatively, a statement can be action oriented, e.g., an assignment, a math operation, a string operation, or an I/O operation. Regardless of the type of statement, once a statement is recognized, the multi-modal compiler 52 invokes the code emitter 74 to emit the machine code to implement the statement.

According to an embodiment, the multi-modal compiler 52, in particular the code emitter 74, can implement the statement in one of two ways. The code emitter 74 can implement the statement using a conventional non-native emission, which includes only non-native operators, such as E-Mode operators. Such emission forms the basis of a non-native code segment 78, which includes non-native (e.g., E-Mode) operators 82 only. Alternatively, the code emitter 74 can implement the statement using the inventive non-native emission, which includes non-native operators, such as E-Mode operators, and NATV operators. Such emission forms the basis of a non-native/NATV or NATV code segment 84, which includes a first or non-native/NATV code segment extension or extension portion 86 that has both non-native (e.g., E-Mode) operators and NATV operators. The NATV code segment 84 also includes a second or normal code segment portion 88 that has native operators for the underlying platform, i.e., the native code that is to be executed by the preceding NATV operator.

The basis for implementing the statement using either the conventional non-native emission or the inventive non-native emission depends on the nature of the statement. More specifically, if the tokens, and the resulting statement, include native code that will result in machine code executable by a native processor, the statement can be implemented using the inventive non-native emission (non-native operators, NATV operators and native code). If the tokens and the resulting statement do not include native code that will result in machine code executable by a native processor, the statement is implemented using the conventional non-native emission (i.e., non-native operators only).

The parser 72 is configured to determine which portions of the source code 36 are native code portions and which portions of the source code 36 are non-native code portions. That is, the parser 72 identifies the native portions, which when compiled and translated in a conventional manner are executable by the native processor 26. The parser 72 also identifies the non-native portions, which are those portions of the source code 36 that would not be executable by the native processor 26 even after being compiled and translated in a conventional manner.

The object code 56 generated by the multi-modal compiler 52 includes a plurality of code segments, e.g., code segments 1 through N. Some of these code segments are non-native code segments 78 (e.g., code segment 3), and thus include only non-native (e.g., E-Mode) operators. However, as discussed hereinabove, according to an embodiment, other code segments are NATV code segments 84 (e.g., code segments 1, 2 and N), and therefore include both non-native (e.g., E-Mode) operators and NATV operators, i.e., a first or non-native/NATV code segment extension 86, as well as native code, i.e., a second or normal code segment portion 88, behind the NATV operator.

As discussed hereinabove, the native code (i.e., the normal code segment portion 88) resides behind the non-native/NATV code segment extension 86 within the non-native/NATV code segment 84. Such code segment arrangement or configuration allows the non-native (e.g., E-Mode) code portion of the non-native/NATV code segment extension 86 to still fill up to its implementation limit for a non-native/NATV code segment extension 86 that is implementation defined. Also, with the native code residing behind the non-native/NATV code segment extension 86, the native code can grow up to a relatively large amount, e.g., up to an implementation defined maximum amount.

In general, the more work that is performed by the native code, the fewer non-native (e.g., E-Mode) operators that are needed, which increases the number of statements that can compile into a non-native/NATV code segment 84. Also, in the non-native/NATV code segment 84, the lowest byte offset of all of the NATV operators delineates the division between the non-native/NATV code segment extension 86 and the normal code segment portion 88.

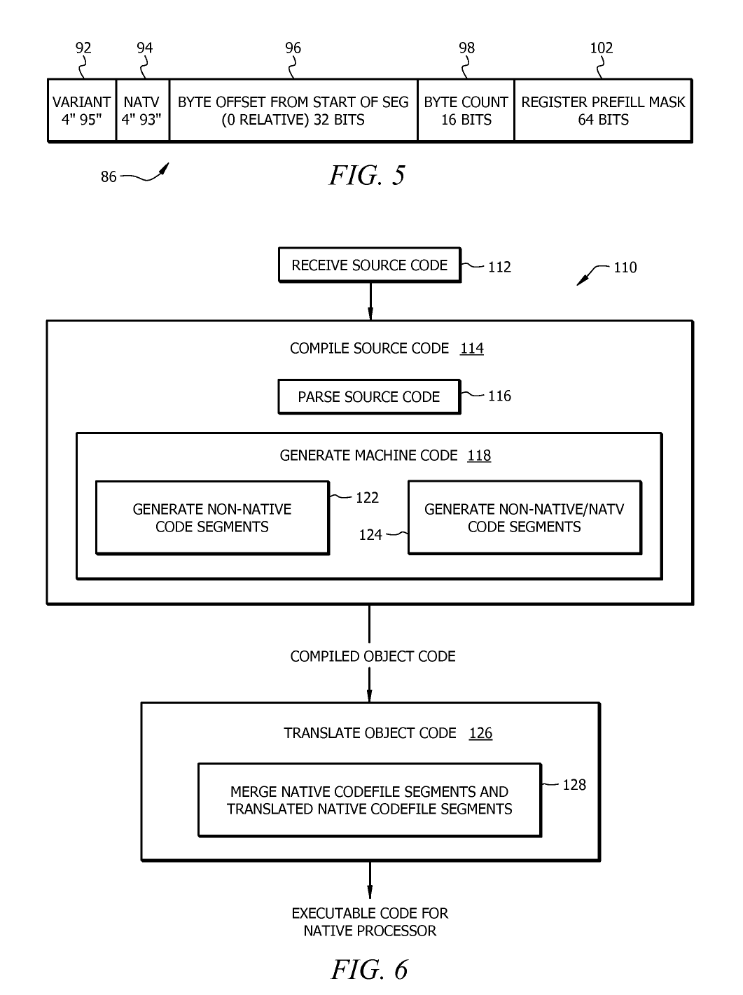

FIG. 5 is a schematic view of the first or non-native/NATV code segment extension 86 of a non-native/NATV or NATV code segment 84. As discussed hereinabove, the non-native/NATV code segment extension 86 includes both non-native operators and NATV operators. It should be understood that the particular layout, arrangement or configuration of the non-native/NATV code segment extension 86 shown in FIG. 5 is exemplary only, and that the non-native/NATV code segment extension 86 can have any suitable configuration.

The non-native/NATV code segment extension 86 includes a variant portion or segment 92 and an NATV portion or segment 94, which collectively comprise the NATV operator. The non-native/NATV code segment extension 86 also includes a byte offset portion or segment 96, a byte count portion or segment 98 and a register prefill mask portion or segment 102. The variant portion 92 typically is 8 bits in length, although it can be any suitable size. The variant portion 92 points to the start of the NATV operator.

The NATV portion or segment 94 typically is 8 bits in length, although it can be any suitable size. The NATV portion or segment 94 includes the particular NATV operator therein. As discussed hereinabove, the NATV operator executes the normal code segment portion 88 that resides behind the non-native/NATV code segment extension 86.

The byte offset portion or segment 96 typically is 32 bits in length, although it can be any suitable size. The byte offset portion or segment 96 references or indexes the start of the normal code segment 88.

The byte count portion or segment 98 typically is 16 bits in length, although it can be any suitable size. The byte count portion or segment 98 identifies the size, in bytes, of the normal code segment portion 88 that resides behind the non-native/NATV code segment extension 86. The byte offset portion or segment 96 and the byte count portion or segment 98 are unsigned integer quantities.

The register prefill mask portion or segment 102 typically is 64 bits in length, although it can be any suitable size. The register prefill mask portion 102 allows the multi-modal compiler 52 to choose up to a number of items (depending on implementation limit), e.g., four (4) items, to be preloaded into certain registers within the native processor 26. For example, for an Intel-based native processor, such as an X64 processor chip, or other X64 or X64-compatible platform, the register prefill mask portion 102 allows the multi-modal compiler 52 to choose up to four (4) items to be preloaded into the RCX, the RDX, the R8 and R9 registers prior to execution of the compiled multi-modal object code 56. In general, for an X64 platform, the RCX, RDX, R8 and R9 registers are used for integer and pointer arguments, in that particular order.

With respect to the register prefill mask portion 102, no more than four (4) bits (depending on implementation limit) may be turned “on” (i.e., logical 1) at any given time. Also, the lowest significant bit that is turned “on” defines what gets loaded into the RCX register. The next significant bit that is turned “on” defines what gets loaded into the RDX register. The next significant bit after that that is turned “on” defines what gets loaded into the R8 register, and the next significant bit after that that is turned “on” defines what gets loaded into the R9 register.

As an example, the bit definitions for the register prefill mask portion 102 can be defined as follows: bit 0 defines the “this” pointer of the current CPM, bit 1 defines the address of the base of the D-registers, bit 2 defines the address of the base of the non-native (e.g., E-Mode) memory, and bit 3 defines the current CPM id (WHOI result) executing the code.

Therefore, for example, for a mask=0000 0010, bit 1 is the least significant bit that is turned “on” and therefore represents what gets loaded into the RCX register. As discussed hereinabove, bit 1 defines or specifies the native address of the base of the D-registers (m_ptrD). Because no other bits are turned “on,” no other registers are preloaded. Therefore, in this example, RCX=Base of D-Regs, RDX=unspecified, R8=unspecified, and R9=unspecified.

In another example, for a mask=0000 0101, bit 0 is the least significant bit that is turned “on” and therefore represents what gets loaded into the RCX register. As discussed hereinabove, bit 0 defines or specifies the “this” pointer of the current CPM. Bit 2 is the next bit that is turned “on” and therefore specifies what gets loaded into the RDX register. As discussed hereinabove, bit 2 defines or specifies the native address of the base of the non-native (e.g., E-Mode) memory. Because no other bits are turned “on,” no other registers are preloaded. Therefore, in this example, RCX=“this” pointer of the current CPM, RDX=Base of E-Mode memory, R8=unspecified, and R9=unspecified.

In general operation, according to an embodiment, when the NATV operator is translated by the code translation unit 54, the NATV operator emits native code 64 (e.g., DBT native code) to prefill the specified registers. The translated NATV operator also copies the code emitted by the multi-modal compiler 52, i.e., the translated native code 62, “inline” with the native code 64. In this manner, the translated native code 62 is “merged” with the native code 64 in the same code segment, i.e., a hybrid code segment or codefile. Also, the translated NATV operator updates the emOpOffset location after the final syllable of the translated native code 62 emitted from the multi-modal compiler 52 has been merged or “inlined” with the native code 64. The emOpOffset location update allows the NATV operator to “consume” the bytes for the opcode.

When the NATV operator executes, the NATV operator flushes the non-native (e.g., E-Mode) stack to memory. Therefore, all of the tops of the stack registers are empty, and the entire non-native (e.g., E-Mode) stack resides in the non-native (e.g., E-Mode) memory. In this manner, the stack items can be worked on directly with native instructions, i.e., instructions from the native instruction set.

FIG. 6 is a flow diagram of a method 110 for generating a hybrid code segment according to an embodiment. The method 110 includes a step 112 of receiving source code, such as source code for a program A. As discussed hereinabove, the multi-modal compiler 52 receives the source code 36 from an appropriate data storage location.

The method 110 also includes a step 114 of compiling the received source code. The multi-modal compiler 52 compiles the source code 36 to generate a compiled multi-modal object code 56. As part of the step 114 of compiling the source code, a step 116 of parsing the source code is performed. The parser 72 parses the received source code 36 into tokens, which form the basis of statement, e.g., as discussed hereinabove.

The compiling step 114 also includes a step 118 of generating or emitting machine code, i.e., compiled multi-modal object code 56. Once a statement is recognized from a collection of tokens, the multi-modal compiler 52 invokes the code emitter 74 to emit the machine code to implement the statement. As discussed hereinabove, the code emitter 74 can implement the statement using a conventional non-native emission, which forms the basis of the non-native code segment 78, which includes only non-native (e.g., E-Mode) operators 82. Such activity is shown generally as a step 122 of generating non-native code segments 78. Alternatively, the code emitter 74 can implement the statement using the inventive non-native emission, forms the basis of the non-native/NATV code segment 84. Such activity is shown generally as a step 124 of generating non-native/NATV code segments 84.

The method 110 also includes a step 126 of translating the compiled multi-modal object code 56. Once the multi-modal compiler 52 has compiled the source code 36 into the multi-modal object code 56, the translator or code translation unit 54 translates the multi-modal object code 56 into the single merged code or codefile 58, which includes one or more translated native code segments 62 and one or more native code segments 64. The translation step 126 includes a step of 128 of merging the native codefile segments 64 and the translated native code segments 62 into a single codefile, i.e., the codefile 58. As discussed hereinabove, all of the code segments in the merged codefile 58 are executable by the native processor 26.

The inventive compilers, systems and methods described herein provide for relatively significant speed improvements in emulated systems, as well as supplying a framework in which a multiplicity of execution environments can be supported with relatively high performance. Also, the compilers, methods and systems described herein allow for a compiler to emit code for more than one processor target with all of the code in a single codefile. At load time, transformations are generated that merge the target processors' code with the necessary perquisite conditions, which, when executed, allow a seamless transition between processors and instruction sets.

The methods illustrated in FIG. 6 may be implemented in a general, multi-purpose or single purpose processor. Such a processor will execute instructions, either at the assembly, compiled or machine-level, to perform that process. Those instructions can be written by one of ordinary skill in the art following the description of FIG. 6 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A multi-modal compiling apparatus, wherein the multi-modal compiling apparatus is a non-native compiler for use in a native computing environment, comprising:
a parser configured for receiving a program source code, wherein the parser is configured to manipulate at least a portion of the program source code into a plurality of token code elements in such a way that at least one statement is recognized from a collection of token code elements; and
a code emitter configured to emit machine code to implement at least one statement, wherein the emitted machine code comprises compiled multi-modal object code corresponding to the program source code, wherein the compiled multi-modal object code includes at least one first or non-native operator and at least one second or NATV operator,
wherein the compiled multi-modal object code is configured to generate a merged codefile having at least one translated native code segment corresponding to the at least one non-native operator and at least one native code segment corresponding to the at least one NATV operator,
wherein the merged codefile is executable by a native processor within the native computing environment.

2. The apparatus as recited in claim 1, wherein the compiled multi-modal object code includes at least one first or non-native code segment and at least one second or non-native/NATV code segment.

3. The apparatus as recited in claim 2, wherein the at least one first or non-native code segment includes at least one non-native operator, and wherein the at least one second or non-native/NATV code segment includes at least one non-native/NATV code segment extension portion having at least one non-native operator and at least one NATV operator.

4. The apparatus as recited in claim 2, wherein the at least one second or non-native/NATV code segment includes at least one second or normal code segment portion residing behind a corresponding NATV operator from a non-native/NATV code segment extension portion.

5. The apparatus as recited in claim 1, wherein the merged codefile is generated by a code translation unit coupled to the multi-modal compiler and configured for receiving compiled multi-modal object code.

6. The apparatus as recited in claim 5, wherein the code translation unit includes a dynamic binary translation (DBT) module that performs dynamic binary translation, and wherein the translated native code segment includes DBT native code.

7. The apparatus as recited in claim 1, wherein the emulated computing environment includes a Master Control Program (MCP) environment, and wherein the operating system in the first computing environment is the MCP operating system, and wherein at least one of the non-native operators includes an E-Mode operator.

8. The apparatus as recited in claim 1, wherein the native computing environment includes a native processor, and wherein the multi-modal compiling apparatus is included within an interpreter, and wherein the interpreter is included within the native processor.

9. An emulated computing environment for use within a native computing environment having a native processor, comprising:
a non-native compiler configured for receiving a program source code, wherein the non-native compiler is configured to generate a compiled multi-modal object code corresponding to the program source code, wherein the compiled multi-modal object code includes at least one first or non-native code segment and at least one second or non-native/NATV code segment; and
a non-native translator coupled to the non-native compiler and configured for receiving compiled multi-modal object code, wherein the non-native translator is configured to generate a merged codefile having at least one translated native code segment corresponding to the at least one non-native operator and at least one native code segment corresponding to the at least one NATV operator,
wherein the merged codefile is configured to be executed by the native processor.

10. The emulated computing environment as recited in claim 9, wherein the at least one first or non-native code segment includes at least one non-native operator, and wherein the at least one second or non-native/NATV code segment includes at least one non-native/NATV code segment extension portion having at least one non-native operator and at least one NATV operator.

11. The emulated computing environment as recited in claim 10, wherein the at least one second or non-native/NATV code segment includes at least one second or normal code segment portion residing behind a corresponding NATV operator from a non-native/NATV code segment extension portion.

12. The emulated computing environment as recited in claim 9, wherein the emulated computing environment includes a Master Control Program (MCP) environment, and wherein the operating system in the first computing environment is the MCP operating system, and wherein at least one of the non-native operators includes an E-Mode operator.

13. The emulated computing environment as recited in claim 9, wherein the non-native translator includes a dynamic binary translation (DBT) module that performs dynamic binary translation, and wherein the translated native code segment includes DBT native code.

14. The emulated computing environment as recited in claim 9, wherein the native computing environment includes a native processor, and wherein the non-native compiler and the non-native translator are included within an interpreter, and wherein the interpreter is included within the native processor.

15. A method for generating a hybrid codefile for execution in a native computing environment, comprising:
receiving a program source code by a parser configured to manipulate at least a portion of the program source code into a plurality of token code elements in such a way that at least one statement is recognized from a collection of token code elements;
emitting machine code by a code emitter configured to implement at least one statement, wherein the emitted machine code comprises compiled multi-modal object code corresponding to the program source code, wherein the compiled multi-modal object code includes at least one first or non-native code segment and at least one second or non-native/NATV code segment; and
translating by a code translation unit the compiled multi-modal object code into a merged codefile having at least one translated native code segment corresponding to the at least one first or non-native code segment and at least one native code segment corresponding to the at least one second or non-native/NATV code segment,
wherein the merged codefile is executable by a native processor within the native processing environment.

16. The method as recited in claim 15, wherein the at least one first or non-native code segment includes at least one non-native operator, and wherein the at least one second or non-native/NATV code segment includes at least one non-native/NATV code segment extension portion having at least one non-native operator and at least one NATV operator.

17. The method as recited in claim 16, wherein the at least one second or non-native/NATV code segment includes at least one second or normal code segment portion residing behind a corresponding NATV operator from a non-native/NATV code segment extension portion.

18. The method as recited in claim 15, wherein the emulated computing environment includes a Master Control Program (MCP) environment, and wherein the operating system in the first computing environment is the MCP operating system, and wherein at least one of the non-native operators includes an E-Mode operator.

19. The method as recited in claim 15, wherein the code translation unit includes a dynamic binary translation (DBT) module that performs dynamic binary translation, and wherein the translated native code segment includes DBT native code.

20. A hybrid code stream, comprising:
at least one first or non-native code segment having at least one non-native code portion; and
at least one second or non-native/NATV code segment having at least one non-native/NATV code segment extension portion, wherein the at least one non-native/NATV code segment portion includes at least one non-native operator and at least one NATV operator, and wherein the at least one second or non-native/NATV code segment includes at least one second or normal code portion residing behind a corresponding NATV operator from,
wherein the hybrid codefile is configured for execution by a native processor.
